(19) United States
(12) Patent Application Publication
(10) Pub. No.: US 2012/0248984 A1
(43) Pub. Date: Oct. 4, 2012

(54) BALLAST AND ASSOCIATED CONTROL CIRCUIT

(75) Inventors: Jin Hu, Hangzhou (CN); Yuancheng Ren, Hangzhou (CN); Junming Zhang, Hangzhou (CN)

(73) Assignee: Chengdu Monolithic Power Systems Co., Ltd., Chengdu (CN)

(21) Appl. No.: 13/434,467

(22) Filed: Mar. 29, 2012

(30) Foreign Application Priority Data
Apr. 1, 2011 (CN) 20112093755.2

(51) Int. Cl. H05B 41/298

(52) U.S. Cl. 315/116

(57) ABSTRACT

The embodiments of the present invention disclose a ballast and associated control circuit wherein the control circuit comprises a multi function pin, a preheat cut-off circuit and an over-voltage protection circuit, wherein the multi function pin is coupled to the preheat cut-off circuit and a first switch configured to turn on the first switch at a preheat state of the ballast and to turn off the first switch at the end of the preheat state, and wherein the multi function pin is further coupled to the over-voltage protection circuit and a voltage sense circuit configured to receive a sensed output voltage signal and to stop the ballast after the preheat state when the sensed output voltage is larger than a first threshold. Compared with prior art, the present invention may reduce the volume and lower down the cost of circuit.

### CROSS-REFERENCE TO RELATED APPLICATION(S)

This application claims the benefit of CN application No. 20112093755.2, filed on Apr. 1, 2011, and incorporated herein by reference.

### TECHNICAL FIELD

The disclosed invention relates to electrical circuit, and more particular relates to electrical ballast and associate control circuit.

### BACKGROUND

Fluorescent lamp ballast is a device used to provide the starting voltage and/or to stabilize the current in a circuit. In general, the fluorescent lamp ballast comprises three states, which are preheat state, ignition state, and burn state. In preheat state, the filaments of the lamp are heated. And the voltage across the lamp is relatively low. In ignition state, the voltage across the lamp is relatively high configured to ignite the lamp. In burn state, the voltage across the lamp is relatively low again.

According to above requirement, a half-bridge structure that working at resonance mode is preferred in a ballast. Commonly, there are two methods for preheating. One is current preheat mode, and the other one is voltage preheat mode.

FIG. 1 illustrates a schematic circuit diagram of a prior art fluorescent lamp in current preheat mode. FIG. 2 illustrates a preheat state equivalent circuit of the circuit shown in FIG. 1. FIG. 3 illustrates a burn-state equivalent circuit of the circuit shown in FIG. 1.

As shown in FIG. 1, a source electrode of a switch M1 is coupled to a drain electrode of a switch M2. A drain electrode of the switch M1 is coupled to a direct current (DC) bus Vdcbus, and a source electrode the switch M2 is coupled to a reference ground. One end of an inductor L is coupled in series to a first end of a capacitor Cs, and the other end of the inductor L is coupled to a common end of switches M1 and M2. A second end of the capacitor Cs is coupled to a first end of a filament, while a second end of the filament is coupled to the reference ground. A capacitor Cp is parallelly coupled to the filament. Seen in FIGS. 1, M1 and M2 are switched in alternate mode. The inductor L, the capacitor Cs and the capacitor Cp comprise a resonance circuit.

FIG. 2 depicts a prior art operating principle of preheating. In the preheat-mode, the lamp is not ignited and resistors R1 and R2 are the equivalent of the filament. A Current flows through the inductor L, the capacitor Cs, the resistor R1, the capacitor Cp and the resistor R2. The power consumption on resistors R1 and R2 heats the filament configured to make the lamp be ignited easily.

When the lamp is ignited, the filament equals to the combination of resistors R, R1 and R2. As shown in FIG. 3, a substantial portion of current flows through resistor R. However there is still a minor portion of current flowing through resistor R1, capacitor Cp and resistor R2. The power consumption on resistors R1 and R2 does not benefit the lamp and decreases the efficiency of the ballast.

FIG. 4 illustrates a schematic circuit diagram of a prior art fluorescent lamp ballast in voltage preheat mode. FIG. 5 illustrates a preheat state equivalent circuit of the circuit shown in FIG. 4. FIG. 6 illustrates a burn-state equivalent circuit of the circuit shown in FIG. 4.

The operating principle of the voltage preheat mode is similar to the current preheat mode. The difference is that a transformer is applied to transfer energy for preheating the filament in FIG. 4, wherein Ta, Tb and Tc are three coils of the transformer. Ta is the primary coil. Ta is coupled in series between an end of a capacitor C1 and a reference ground. The other end of the capacitor C1 is coupled to the common end of switches M1 and M2. Tb is coupled in series between an end of a capacitor Cf1 and a first end of the filament. Tc is coupled in series between an end of a capacitor Cf2 and a second end of the filament. When the circuit shown in FIG. 4 begins to operate, M1 and M2 switch in alternate mode. A square wave is generated at the source electrode of M1. Seen in FIG. 5, in preheat state, C1 resonates with the primary coil Ta. The energy is transferred to secondary coils Tb and Tc configured to heat the filament. When the preheat state is finished, the operating frequency of M1 and M2 decrease. L, Cs, Cp comprises a resonance network configured to generate a relatively high voltage on Cp to ignite the lamp. Since the filament has been preheated, the lamp could be ignited with a relatively low voltage.

Because of the relationship among the three coils Ta, Tb and Tc, energy flows through the filament when the lamp is in burn-state. The power consumption on resistors R1 and R2 could not be converted into light. Thus the efficiency of the ballast is lowered.

In order to save power consumption of R1 and R2 in burn state, a cut-off circuit is applied to stop preheat circuit in burn-state. FIG. 7 illustrates a cut-off circuit according to a prior art. The difference from the circuit shown in FIG. 4 is that a switch M3 is coupled in series between Ta and the reference ground, wherein a drain electrode is coupled to Ta and wherein a source electrode is coupled to the reference ground.

In preheat state, switch M3 turns on. Then the energy transferred by the transformer could heat the filament. When preheating is over, switch M3 turns off, and the transformer stops operating. The filament resistance is no longer heated, and thus the efficiency of the ballast might be improved.

Usually an integrated circuit (IC) may be utilized as a ballast control circuit to generate control signals to the switches and to provide protection for preventing damage from abnormal state. The preheat cut-off circuit shown in FIG. 7 may solve the power consumption problem of resistors R1 and R2 at burn state. However switch M3 is needed. For generating the control signal of switch M3, the pin number of IC is also increased. It has such drawbacks as larger volume and higher cost of IC.

### SUMMARY

One embodiment of the present invention discloses a ballast control circuit to control a ballast. The ballast control circuit comprises a multi function pin, a preheat cut-off control circuit, and an over-voltage protection circuit. Wherein the multi function pin may be coupled to a voltage sense circuit configured to receive a sensed output voltage signal, and wherein the multi function pin is further coupled to a control end of a first switch, and further wherein the first switch is coupled between a primary coil of a transformer and a reference ground. The preheat cut-off control circuit may be coupled to the multi function pin, configured to control the first switch, wherein the preheat cut-off control circuit turns on the first switch in a preheat state of the ballast, and wherein the preheat cut-off control circuit turns off the first switch at the end of the preheat state. The over-voltage protection circuit may be coupled to the multi function pin, configured to receive the sensed output voltage signal and wherein after the preheat state, the over-voltage protection circuit is configured to disable the ballast when the sensed output voltage signal is larger than a first threshold.

### BRIEF DESCRIPTION OF THE DRAWINGS

Non-limiting and non-exhaustive embodiments are described with reference to the following drawings. The drawings are only for illustration purpose.

FIG. 1 illustrates a schematic circuit diagram of a prior art current preheat mode ballast.

FIG. 2 illustrates a preheat state equivalent circuit of the ballast circuit shown in FIG. 1.

FIG. 3 illustrates a burn state equivalent circuit of the ballast circuit shown in FIG. 1.

FIG. 4 illustrates a schematic circuit diagram of a prior art voltage preheat mode ballast.

FIG. 5 illustrates a preheat state equivalent circuit of the ballast circuit shown in FIG. 4.

FIG. 6 illustrates a burn state equivalent circuit of the ballast circuit shown in FIG. 4.

FIG. 7 illustrates a schematic circuit diagram of a prior art ballast with a preheat cut-off circuit.

FIG. 8 illustrates a schematic circuit diagram of a prior art ballast with an over-voltage protection circuit.

FIG. 9 illustrates a schematic circuitry diagram of a ballast circuit according to an embodiment of the present invention.

FIG. 10 illustrates a voltage waveform diagram of the ballast shown in FIG. 9 according to an embodiment of the present invention.

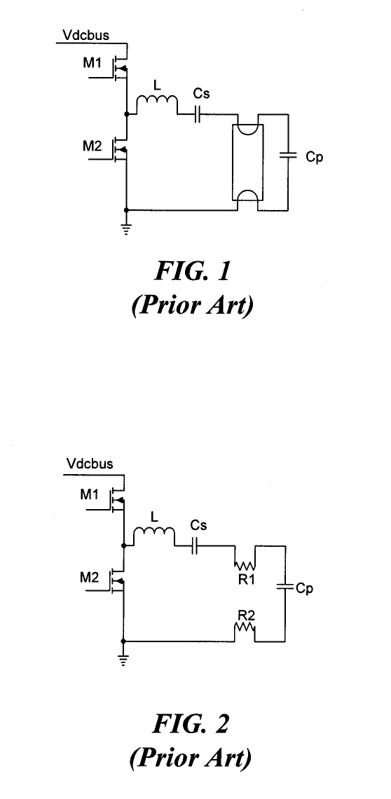

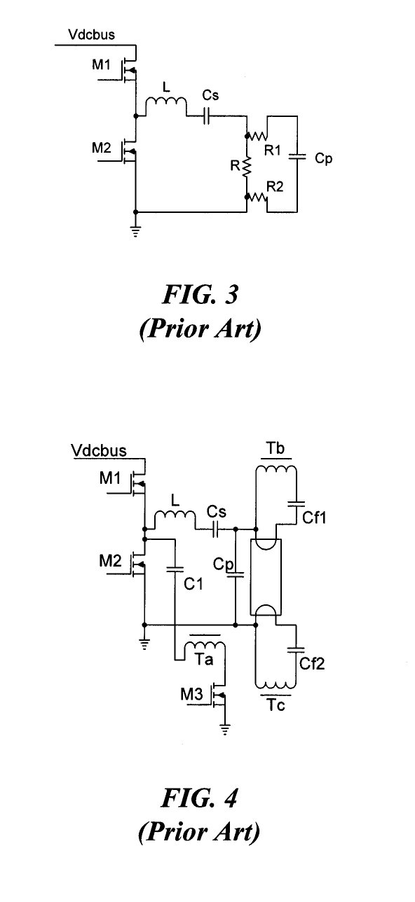

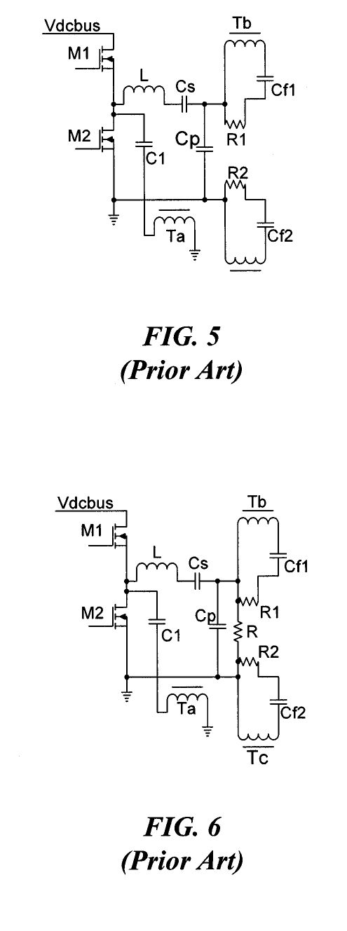

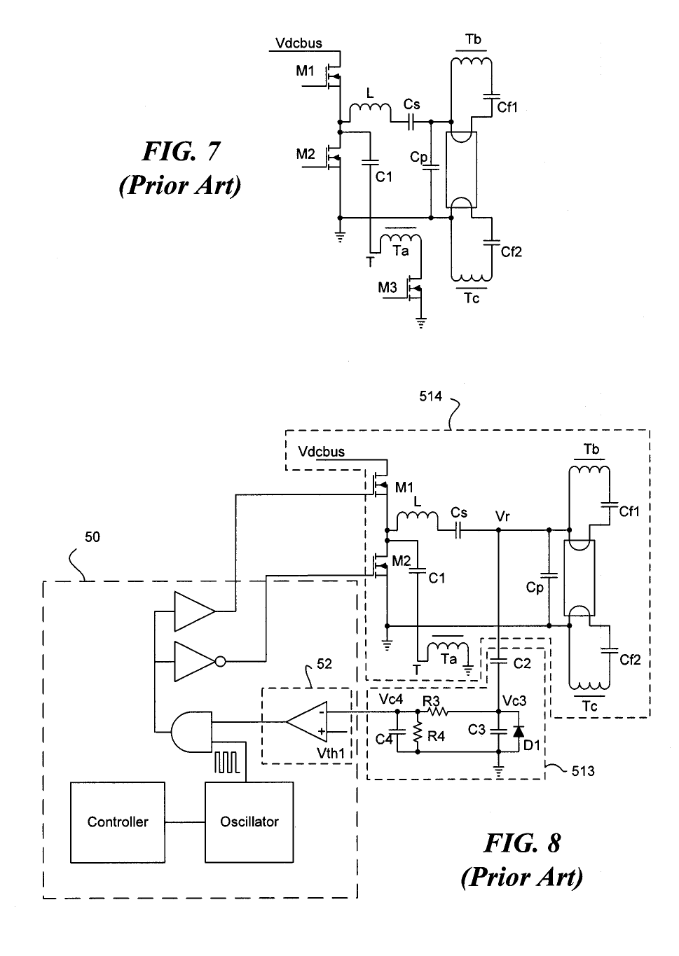

The use of the same reference label in different drawings indicates the same or like components.

### DETAILED DESCRIPTION

The following description and discussion about specific embodiments of the present invention is for purposes of illustration. However, one with ordinary skill in the relevant art should know that the invention is not limited by the specific examples disclosed herein. Variations and modifications can be made on the apparatus, methods and technical design described above. Accordingly, the invention should be viewed as limited solely by the scope and spirit of the appended claims.

The term “couple” hereby and in the following text indicates that an element is directly connected to another element or connected with another element through one or more mediate element. On the contrast, the term “directly connect” hereby and in the following text indicates that an element is connected to another element without any mediate element.

It should be understood that although “first,” “second,” “third” and other ordinal number are applied to describe certain elements, components or parts, these elements, components or parts are not limited by such ordinal numbers. The ordinal numbers hereby and in the following text are for the purpose of distinguishing only.

FIG. 8 illustrates a schematic circuitry diagram of a prior art electrical ballast circuit with an over-voltage protection circuit 52. Seen in FIG. 8, the ballast circuit comprises a half-bridge inverting circuit 514 and a ballast control circuit 50. Hereby ballast control circuit 50 is an integrated circuit (IC). The inverter circuit 514 comprises a pair of switches M1 and M2, a resonance circuit which comprises an inductor L, a capacitor Cs and a capacitor Cp, and a transformer which comprises three coils Ta, Tb and Tc. Ballast control circuit 50 generates driver signals to control the switches M1 and M2. Generally, the ballast control circuit 50 may comprise pins to detect errors such as over-voltage issue, over-current issue and over-temperature issue. As shown in FIG. 8, a voltage sense circuit 513 is coupled between a first pin of the ballast control circuit 50 and the half-bridge inverting circuit 514, wherein the voltage sense circuit 513 comprises capacitors C2, C3 C4 and resistors R1 and R2. Capacitors C2 and C3 comprise a cap divider. Vr is an output alternating voltage (AC voltage) of the half-bridge inverting circuit 514. The cap divider receives the AC voltage configured to generate a voltage signal Vc3. The Vc3 is further provided to a resistor divider comprised by resistors R3 and R4. The resistor divider generates a sensed output voltage signal Vc4 of the voltage sense circuit 514 on a capacitor C4. The capacitor C4 and the resistor R3 comprise a filter with the function of filtering and delay. A diode D1 clamps a negative voltage on the C3 configure to prevent a high negative voltage damaging the IC. Once Vr increases, the Vc3 and Vc4 also increase. If the sensed output voltage signal Vc4 of voltage sense circuit 514 is larger than a first threshold voltage Vth1, the half-bridge inverting circuit for supplying energy to the lamp is stopped by the over-voltage protection circuit 52,

Embodiments of the present invention disclose a method of applying one pin to achieve both preheat cut-off function and over-voltage protection function. It may decrease the number of IC pins and thus lower the cost and minimize the device of periphery circuit.

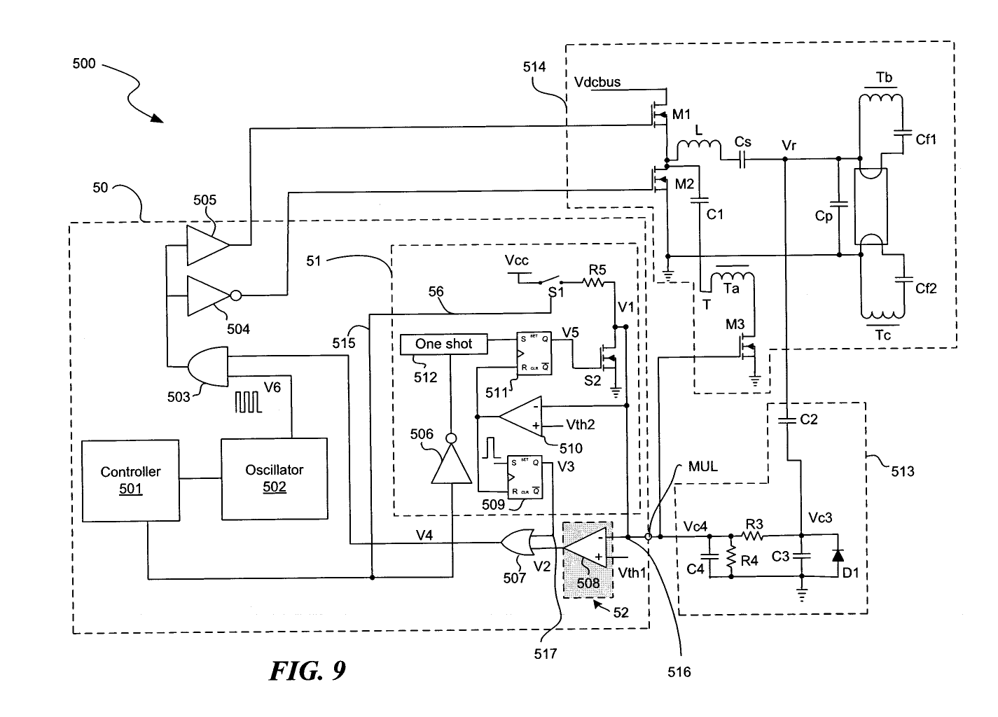

FIG. 9 illustrates a schematic circuitry diagram of an electrical ballast 500 according to an embodiment of the present invention. Beside the voltage sense circuit shown in FIG. 8, the ballast control circuit 50 comprises both a preheat cut-off control circuit 51 and an over-voltage protection circuit 52. When the preheat state is over, ballast control circuit 50 cuts off the transformer. And when the output voltage signal Vc4 of the voltage sense circuit 513 is larger than the first threshold voltage Vth1, the half-bridge inverting circuit 514 for supplying energy to the lamp is stopped by the over-voltage protection circuit 52. Thus at the burn-state of the lamp, the efficiency of the ballast is improved and also over-voltage protection is provided for the ballast.

Continuing in FIG. 9, a switch M3 is coupled in series between the primary coil Ta and the reference ground, wherein a drain electrode of M3 is coupled to the Ta and wherein a source electrode of M3 is coupled to the reference ground. A gate electrode of M3 is controlled by the preheat control circuit 51 from a multi function pin MUL of the ballast control circuit 50. When the preheat state is over, the switch M3 is cut off configured to stop the transformer. Therefore the filament has no energy to heat. In additional, the multi function pin MUL of the ballast control circuit 50 is further coupled to the output end of the voltage sense circuit 513 configured to receive the sensed output voltage signal Vc4, and coupled to the over-voltage protection circuit 52. After preheat state, if the sensed output voltage signal Vc4 is larger than the first threshold voltage Vth1, the driver signals G1 and G2 which are for the switches M1 and M2 respectively are disabled by the over-voltage protection circuit 52. Therefore the switches M1 and M2 are cut off to stop supplying energy to the lamp.

The ballast control circuit 50 comprises: a controller 501, wherein the controller 501 comprises a first output end and a second output end, wherein the first output end is coupled to an oscillator 502 configured to regulate the oscillation frequency of an oscillator 502, and wherein the second output end generates a preheat control signal 56 to indicate whether the ballast is in preheat state; oscillator 502, comprising an input end and an output end, wherein the input end is coupled to the first output end of controller 501, and wherein the output end is coupled to the driver signals G1 and G2 configured to control the switches M1 and M2 to operate alternatively; the preheat cut-off control circuit 51, comprising an input end 515, a first output end 516 and a second output end 517, wherein the input end 515 is coupled to the second output end of controller 501 and wherein the first output end 516 is coupled to the multi function pin MUL configured to turn the switch M3 on and off according to the preheat control signal 56; the over-voltage protection circuit 52, comprising a first input end, a second input end, and an output end, wherein the first input end is coupled to the multi function pin MUL configured to receive the output voltage signal Vc4 sensed by the voltage sense circuit 513, and wherein the second input end is coupled to the first threshold voltage Vth1, the over-voltage protection circuit 52 disabling the driver signals G1 and G2 when the sensed output voltage signal Vc4 is larger than the first threshold voltage Vth1; an OR gate 507, comprising a first input end, a second input end and an output end, wherein the first input end is coupled to the second output end 517 of the preheat cut-off control circuit 51, and wherein the second input end is coupled to the output end of the over-voltage protection circuit 52; and an AND gate 503, comprising a first input end, a second input end and an output end, wherein the first input end is coupled to the output end of the OR gate 507, and wherein the second input end is coupled to the output end of the oscillator 502, and wherein the output end is coupled to the gates of switches M1 and M2.

The preheat cut-off control circuit 51 comprises: a switch S1, having an first end which is coupled to the power supply voltage Vcc, wherein the switch S1 is controlled by the preheat control signal 56; a switch S2, wherein a source electrode of the switch S2 is connected to the reference ground and wherein a drain electrode of the switch S2 is coupled with the multi function pin MUL; a resistor R5, coupled between a second end of the switch S1 and the drain electrode of the switch S2; a first flip-flop 511, wherein an output end of the first flip-flop 511 is coupled to a gate electrode of the switch S2; a second flip-flop 509, wherein a S end of the second flip-flop 509 receives a pulse reset signal when the preheat state is beginning, and wherein an output end of the second flip-flop 509 coupled to the first input end of the OR gate 507 serves as the second output end 517 of the preheat cut-off control circuit 51; a second comparator 510, wherein a non-inverting input end of the second comparator 510 is coupled to a second threshold voltage Vth2, and wherein an inverting input end of the second comparator 510 is coupled to the multi function pin MUL, and, where an output end of the second comparator 510 is coupled to R ends of the first flip-flop 511 and the second flip-flop 509 respectively; an inverter 506, wherein an input end of the inverter receives a preheat control signal 56 from the controller 501, and wherein an output end is coupled to a S end of the first flip-flop 511 through a one shot circuit 512; One shot circuit 512, generating a pulse reset signal at the end of the preheat state according to the output of the inverter 506.

The over-voltage protection circuit 52 comprises: a first comparator 508, wherein an inverting input end of the first comparator 508 is coupled to the pin MUL and wherein a non-inverting input end of the first comparator 508 receives the first threshold voltage Vth1, and wherein an output end of the first comparator 508 is coupled to the second input end of the OR gate 507.

The first threshold Vth1 is larger than the second threshold voltage Vth2. The Vth1 which decides the over-voltage point is set according to the values of C2, C3, R3 and R4. The second threshold voltage Vth2 is smaller than the Vth1, e.g., 200 mV. The second threshold voltage Vth2 represents the reset voltage portion of the voltage Vc4 on the capacitor C4 at the end of preheat state.

The following table is the truth table of the first flip-flop 511 and the second flip-flop 509:

| R | S | Q |
|---|---|---|
| 0 | 1 | 1 |
| 1 | 0 | 0 |
| 0 | 0 | unchanged |
| 1 | 1 | according to priority |

As shown in FIG. 9, controller 501 generates a high level preheat control signal 56 in the preheat state, and generates a low level preheat control signal 56 in the ignition state and burn state. The preheat control signal 56 controls the switch S1 on and off. When the preheat control signal 56 is in high level, the switch S1 is on. While the preheat control signal 56 is in low level, the switch S1 is off.

The ballast control circuit 50 further comprises: a first driver circuit 505, wherein an input end of the first driver circuit 505 is coupled to the output end of the AND gate 503, and wherein an output end of the first driver circuit 505 is coupled to the gate electrode of the switch M1; and a second driver circuit 504, wherein an input end of the second driver circuit 504 is coupled to the output end of the AND gate 503 and wherein an output end of the second driver circuit 504 is coupled to the gate electrode of the switch M2.

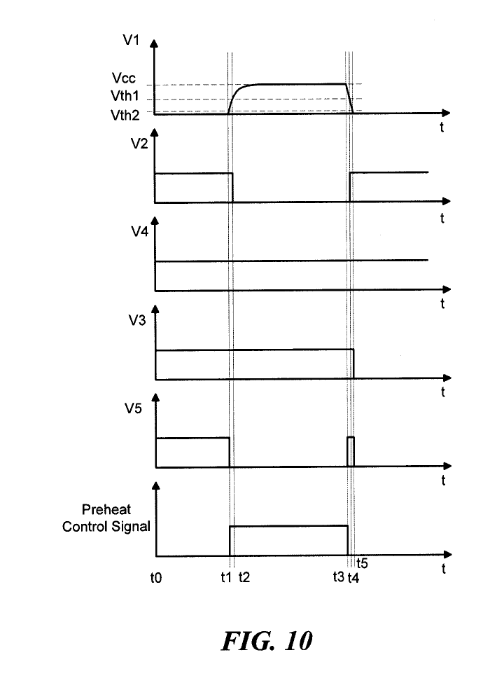

FIG. 10 illustrates a voltage waveform diagram of the ballast shown in FIG. 9 according to one embodiment of the present invention. With the voltage waveform, the operation process of the ballast is described in the following.

Seen in FIG. 10, in the period t1˜t3, the ballast is in the preheat state. The sensed output voltage signal Vc4 is applied as the control voltage for the gate electrode of the switch M3. Because the switch S1 is on and the switch S2 is off, the power supply voltage charges the capacitor C4 through the resistor R5. The voltage Vc4 is gradually increased. When Vc4 is larger than the threshold voltage of the switch M3, M3 is on and the ballast preheats the filament through the transformer.

At the beginning of the preheating, the S end of the second flip-flop 509 is provided a pulse reset signal, which makes the output voltage V3 of the flip-flop 509 is in high level. Since Vc4>Vth2 in preheat state, the second comparator 510 generates a low level voltage signal to the R end of the second flip-flop 509. Thus the output voltage V3 of the second flip-flop 509 is kept in high level and the output voltage V4 of the OR gate 507 is also in high level. The driver signal V6 is transmitted to the gate electrodes of the switches M1 and M2. Although during the period t2˜t3 (preheat state), Vc4>Vth1, the over-voltage protection circuit 52 is disabled because the output voltage V2 of the first comparator 508 could not generate a low level output signal on the OR gate 507.

During the period t3˜t4, the preheat state is over. The preheat control signal 56 changes into low level, and thus the switch S1 turns off. The one-shot circuit 512 generates a pulse reset signal to the S end of the first flip-flop 511 according to the rising-edge of the inverted preheat control signal 56. Meanwhile Vc4>Vth2, so the second comparator 510 generates a low level voltage to the R end of the first flip-flop 511. The output end Q of the first flip-flop 511 generates a high level voltage V5 to turn the switch S2 on. The capacitor C4 begins to discharge to the reference ground through the switch S2 and then the Vc4 is decreased smaller than Vth2 at the moment t5. As Vc4<Vth2, the second comparator 510 generates a high level voltage to the R ends of the first flip-flop 511 and the second flip-flop 509. And the S end of the first flip-flop is in low level. The output voltage V5 of the first flip-flop 511 turns to low level to cut the switch S2 off. At the same time, the S end of the second flip-flop 509 is in low level, therefore the output voltage V3 of the second flip-flop 509 is in low level. The output voltage V4 of the OR gate 507 depends on the output voltage V2 of the first comparator 508, and thus the over-voltage protection circuit 52 is enabled.

At this moment, the preheat state is over. Vc4 is applied as a sensed output voltage signal of the lamp voltage Vr. Normally, Vc4<Vth1. The output voltage V2 of the first flip-flop 511 is in high level, and the output voltage V4 of the OR gate 507 is also in high level. The driver signal generated from the oscillator 502 controls the switches M1 and M2 to operate in alternate mode.

Once an over-voltage error occurred on the lamp, the Vc4>Vth1. The output voltage V2 of the first flip-flop 511 is in low level. Also Vc4>Vth2, the second comparator 510 generates a low level voltage signal to the R end of the second flip-flop 509. As the S end of the second flip-flop 509 is in low level, the output voltage signal V3 of the second flip-flop 509 is kept in low level. As a result, the OR gate 507 generates a low level output voltage signal V4 configured to disable the driver signal from the oscillator 502 in the AND gate 503. The G1 and G2 are in low level and the switches M1 and M2 stop operating.

According to the above description, in order to prevent the Vc4 turning on the switch M3 in the situation when an error occurred on the lamp in burn state, the capacitance of the capacitors C2, C3 and the resistance of the resistors R3 and R4 may be set to obtain a proper value of the sensed output voltage signal Vc4.

The above description and discussion about specific embodiments of the present invention is for purposes of illustration. However, one with ordinary skill in the relevant art should know that the invention is not limited by the specific examples disclosed herein. Variations and modifications can be made on the apparatus, methods and technical design described above. Accordingly, the invention should be viewed as limited solely by the scope and spirit of the appended claims.

I/We claim:

1. A ballast control circuit to control a ballast, comprising:
a multi function pin, wherein the multi function pin is coupled to a voltage sense circuit from which the multi function pin receives a sensed output voltage signal, and wherein the multi function pin is further coupled to a control end of a first switch, wherein the first switch is coupled between a primary coil of a transformer and a reference ground;
a preheat cut-off control circuit, coupled to the multi function pin, configured to control the first switch, wherein the preheat cut-off control circuit turns on the first switch when the ballast is in a preheat state, and wherein the preheat cut-off control circuit turns off the first switch at the end of the ballast preheat state; and
an over-voltage protection circuit, coupled to the multi function pin, configured to receive the sensed output voltage signal, wherein after the ballast preheat state, the over-voltage protection circuit is configured to disable the ballast when the sensed output voltage signal is larger than a first threshold.

2. The ballast control circuit according to claim 1, further comprising:
a controller, having a first output end and a second output end, wherein the second output end is configured to provide a preheat control signal;
an oscillator, having an input end and an output end, wherein the input end is coupled to the first output end of the controller, and wherein the output end is configured to provide a driving signal, and further wherein the first output end of the controller is configured to regulate the frequency of the driving signal;
an OR gate, having a first input end, a second input end, and an output end; and
an AND gate, having a first input end, a second input end and an output end, wherein the first input end is coupled to the output end of the OR gate, the second input end is coupled to the output end of the oscillator;
wherein the preheat cut-off control circuit has an input end, a first output end, and a second output end, further wherein the input end is coupled to the second output end of the controller, and the first output end is coupled to the multi function pin, and the second output end is coupled to the first input end of the OR gate; and
wherein the over-voltage protection circuit has a first input end, a second input end, and an output end, further wherein the first input end is coupled to the multi function pin, and the second input end is coupled to the first threshold, and the output end is coupled to the second input end of the OR gate.

3. The ballast control circuit according to claim 2, further comprising:
a first driver circuit, having an input end and an output end, wherein the input end is coupled to the output end of the AND gate, and wherein the output end is coupled to a gate terminal of a high side switch of an inverting circuit; and
a second driver circuit, having an input end and an output end, wherein the input end is coupled to the output end of the AND gate, and wherein the output end is coupled to a gate terminal of a low side switch of the inverting circuit.

4. The ballast control circuit according to claim 2, wherein the over-voltage protection circuit comprises a first comparator, the first comparator having an inverting input, a non-inverting input end and an output end, wherein the inverting input end is coupled to the multi function pin, and the non-inverting input end is coupled to the first threshold voltage, and further the output end is coupled to the second input end of the OR gate.

5. The ballast control circuit according to claim 2, wherein the preheat cut-off control circuit comprises:
a second switch, having an first end, a second end and a control end, wherein the first end is coupled to a power supply voltage, and wherein the preheat control signal is coupled to the control end for controlling the second switch;
a third switch, having a source electrode, a drain electrode and a gate electrode, wherein the source electrode is connected to the reference ground and wherein the drain electrode is coupled to the multi function pin;
a resistor, coupled between the second end of the second switch and the drain electrode of the third switch;
a first flip-flop, having an S end, a R end and an output end, wherein the S end is coupled to the preheat control signal, and wherein the output end is coupled to the gate electrode of the third switch;
a second flip-flop, having an S end, a R end and an output end, wherein the S end is coupled to a pulse reset signal, and wherein the output end serves as the second output end of the preheat cut-off control circuit;
a second comparator, having an inverting input end, a non-inverting input end and an output end, wherein the non-inverting input end of the second comparator is coupled to a second threshold voltage, and wherein the inverting input end is coupled to the multi function pin, and further wherein the output end is coupled to the R ends of both the first flip-flop and the second flip-flop;
an inverter, having an input end and an output end, wherein the input end is configured to receive the preheat control signal; and
a one-shot circuit, having an input end and an output end, wherein the input end is coupled to the output end of the inverter, and wherein the output end is coupled to the S end of the first flip-flop to provide a pulse reset signal at the end of the preheat state.

6. A ballast, comprising:
an inverting circuit, configured to supply power to a lamp, wherein the inverting circuit comprises a high side switch, a low side switch, a transformer and a resonance circuit, wherein the transformer has a primary coil;
a first switch, coupled in series between the primary coil and a reference ground, the first switch having a first end, a second end and a control end;
a voltage sense circuit, having an input end and an output end, wherein the input end is coupled to the lamp, and wherein the output end is configured to provide a sensed output voltage signal; and
a ballast control circuit, comprising a multi function pin, a preheat cut-off control circuit, and an over-voltage protection circuit:
wherein the multi function pin is coupled to the control end of the first switch and the preheat cut-off control circuit, and wherein the ballast control circuit is configured to turn on the first switch in a preheat state of the ballast, and further wherein the preheat cut-off control circuit is configured to turn off the first switch at the end of the preheat state; and
wherein the multi function pin is further coupled to the output end of the voltage sense circuit and the over-voltage protection circuit, wherein after preheat state, the over-voltage protection circuit is configured to stop the inverting circuit when the sensed output voltage is larger than a first threshold voltage.

7. The ballast according to claim 6, wherein the ballast control circuit further comprises:
a controller, having a first output end and a second output end, wherein the second output end is configured to provide a preheat control signal;
an oscillator, having an input end and an output end, wherein the input end of the oscillator is coupled to the first output end of the controller, and wherein the output end of the oscillator is configured to provide a driving signal, and further wherein the first output end of the controller is configured to regulate the frequency of the driving signal;
an OR gate, having a first input end, a second input end and an output end; and
an AND gate, having a first input end, a second input end and an output end, wherein the first input end is coupled to the output end of the OR gate, and wherein the second input end is coupled to the output end of the oscillator;
wherein the preheat cut-off control circuit has an input end, a first output end and a second output end, further wherein the input end is coupled to the second output end of the controller, and the first output end is coupled to the multi function pin, and the second output end is coupled to the first input end of the OR gate; and
wherein the over-voltage protection circuit has a first input end, a second input end and an output end, further wherein the first input end is coupled to the multi function pin, and the second input end is coupled to the first threshold, and the output end is coupled to the second input end of the OR gate.

8. The ballast according to claim 7, wherein the over-voltage protection circuit comprises a first comparator, the first comparator having an inverting input, a non-inverting input end and an output end, further wherein the inverting input end is coupled to the multi function pin, and the non-inverting input end of the first comparator is coupled to the first threshold voltage, and the output end of the first comparator is coupled to the second input end of the OR gate.

9. The ballast according to claim 7, wherein the preheat cut-off control circuit comprises:
a second switch, having an first end, a second end and a control end, wherein the first end is coupled to a power supply voltage, and wherein the preheat control signal is coupled to the control end for controlling the second switch;
a third switch, having a source electrode, a drain electrode and a gate electrode, wherein the source electrode is connected to the reference ground and wherein the drain electrode is coupled to the multi function pin;
a first resistor, coupled between the second end of the second switch and the drain electrode of the third switch;
a first flip-flop, having an S end, a R end and an output end, wherein the S end is coupled to the preheat control signal, and wherein the output end of the first flip-flop is coupled to the gate electrode of the second switch;
a second flip-flop, having an S end, a R end and an output end, wherein the S end is coupled to a pulse reset signal at the beginning of preheat state, and wherein the output end serves as the second output end of the preheat cut-off control circuit;
a second comparator, having an inverting input end, a non-inverting input end and an output end, wherein the non-inverting input end is coupled to a second threshold voltage, and wherein the inverting input end is coupled to the multi function pin, and further where an output end is coupled to the R ends of the first flip-flop and the second flip-flop;
an inverter, having an input end and an output end, wherein the input end of the inverter is coupled to the preheat control signal; and
a one-shot circuit, having an input end and an output end, wherein the input end is coupled to the output end of the inverter, and wherein the output end is coupled to the S end of the first flip-flop to provide a pulse reset signal at the end of the preheat state.

10. The ballast according to claim 7, wherein the control circuit further comprising:
a first driver circuit, having an input end and an output end, wherein the input end is coupled to the output end of the AND gate, and wherein the output end is coupled to a gate terminal of the high side switch of the inverting circuit; and
a second driver circuit, having an input end and an output end, wherein the input end is coupled to the output end of the AND gate, and wherein the output end is coupled to a gate terminal of the low side switch of the inverting circuit.

11. The ballast according to claim 6, wherein the voltage sense circuit comprises:
a cap divider, having a first end, a second end and a common end, the cap divider further comprising a first capacitor and a second capacitor, wherein the first capacitor and the second capacitor is coupled together at the common end, and wherein the first end of the cap divider is coupled to the lamp, and further wherein the second end of the cap divider is coupled to the reference ground;
a voltage clamping circuit, coupled to the second capacitor in parallel;
a resistor divider, having a first end, a second end and a common end, the resistor divider further comprising a second resistor and a third resistor, wherein the second resistor and the third resistor is coupled together at the common end, and wherein the first end is coupled to the common end of the cap divider, and further wherein the second end is coupled to the reference ground; and
a third capacitor, having a first end and a second end, wherein the first end is coupled to both the common end of the resistor divider, and the multi function pin, and wherein the second end is coupled to the reference ground.

12. The ballast according to claim 11, wherein the voltage clamping circuit comprises a diode.

13. A method for controlling a ballast, comprising:
generating a preheat control signal to indicate a ballast state;
at a ballast preheat state , turning on a first switch through a multi function pin, wherein the first switch is coupled between a primary coil of the ballast and a reference ground;
at the end of the ballast preheat state, turning off the first switch through the multi function pin; and
after the ballast preheat state, detecting an output voltage of the ballast through the multi function pin and turning off the ballast when the output voltage is larger than a threshold voltage.

14. The method for controlling a ballast according to claim 13, wherein turning on the first switch comprises:
generating the preheat control signal to indicate the beginning of the ballast preheat state;
turning on the first switch according to the preheat control signal; and
disabling an over-voltage protection circuit according to the preheat control signal.

15. The method for controlling a ballast according to claim 13, wherein turning off the first switch comprising:
generating a preheat control signal to indicate the end of the ballast preheat state;
turning off the first switch according to the preheat control signal; and
enabling the over-voltage protection circuit according to the preheat control signal.

16. The method for controlling a ballast according to claim 13, wherein turning off the ballast comprising:
comparing the output voltage with the threshold voltage;
generating the preheat control signal to indicate the ballast out of the preheat state;
enabling the over-voltage protection circuit according to the preheat control signal; and
disabling the inverting circuit when the output voltage is larger than the threshold voltage.
